(19) United States
(12) Patent Application Publication
(10) Pub. No.: US 2010/0217806 A1
(43) Pub. Date: Aug. 26, 2010

(54) Email Based Remote Management of Network Connected Entities

(76) Inventors: Gautam Khot, Bangalore (IN); Prithvi Ranganath, Bangalore (IN); Raghuram Belur, Bangalore (IN); Sandeep Lakshmipathy, Bangalore (IN)

Correspondence Address: MEYERTONS, HOOD, KIVLIN, KOWERT & GOETZEL, P.C., P.O. BOX 398, AUSTIN, TX, 78767-0398, US

(21) Appl. No.: 12/389,902

(22) Filed: Feb. 20, 2009

(51) Int. Cl. G06F 15/16

(52) U.S. Cl. 709/206; 709/204

(57) ABSTRACT

Managing a device using email messages. New messages of an email address of the device may be checked on a server. An email message may be downloaded from the server based on said checking. The email message may be addressed to the email address of the device. The body of the email message may include one or more commands for the device. The one or more commands contained in the email message may be executed. The one or more commands may include at least one command for initiating or joining a videoconference. Accordingly, execution of the one or more commands may result in the device joining or initiating a videoconference.

### FIELD OF THE INVENTION

The present application relates to managing devices, such as videoconferencing devices.

### DESCRIPTION OF THE RELATED ART

Network devices are extensively used throughout the enterprise, ranging from PCs, servers, routers, phone systems, phones and video conferencing endpoints. Management of these increasing number of network devices requires specialized management applications and trained IT (Information Technology) personnel. It would be desirable to alleviate some of the management hurdles faced by network administrators and support personnel in managing disparate network devices in IT networks.

In the case of network connected devices that are deployed within enterprises, troubleshooting when an issue crops up is a challenging task due to the following reasons:

1) These network connected devices are within a corporate firewall environment and thereby prevent management operations from being initiated by support personnel who are outside the corporate network.

2) IT administrators must be aware of the specific command sets for these devices to initiate any management operations. IT administrators need to learn one or more management tools that provide management functionality for these network connected devices and use these application(s) to manage them.

3) Different versions of software that may be deployed on different network entities may have differences in the command set.

4) Access to management operations requires that the administrator use a specialized management application that may not be accessible at all time.

5) IT administrators must use/access a management/monitoring application to access endpoints for troubleshooting. IT administrators might not have access to a computer with the required toolset installed at all times.

Currently, access to network devices deployed in an enterprise is only through well known protocols like HTTP, telnet, SSH, FTP etc. An administrator may be required to have access to the remote session on these devices to perform diagnostic queries. Also, an IT administrator has to deal with a wide range of APIs and software versions in order to obtain the required information and set specific details from devices during troubleshooting situations.

### SUMMARY OF THE INVENTION

Various embodiments are presented of a method for managing a device.

The device may check (e.g., poll) for new messages on a server, such as an email server. The device may check poll for the new messages using an email address that is specifically for the device. The device may download an email message from the server where a new message is available. For example, the email message may be addressed to the email address of the device, and a body of the email message may include one or more commands for the device.

The device may be a videoconferencing device and the one or more commands may include at least one command for initiating or joining a videoconference. Thus an administrator can send an email message addressed to a videoconferencing device on a network. The email message may be received by an email server on the network. The videoconferencing device may obtain the email message from the server and execute one or more commands in the body or subject of the message, which causes the videoconferencing device to join a videoconference. The device may also perform certain videoconferencing actions based on execution of the at least one command.

In some embodiments, the sender of the email message may be determined and/or authenticated prior to execution of the commands. Permissions of the sender may also be determined.

The one or more commands included in the email message may be automatically executed by the device, wherein this automatic execution is without manual user input required to specify execution of the commands. Thus, upon receipt of the email message software running on the device may execute the commands automatically, without the user having to intervene to manually request or specify the execution. In one embodiment, the user may be prompted with a message to confirm that the email message execution can proceed.

Where the identity and permissions of the sender are determined, execution may depend on the identity and/or permissions of the sender. For example, the one or more commands may not be executed if the sender does not have proper permissions. The permissions can be pre-configured on the endpoints or can be looked up in an enterprise directory, as desired.

The method described above may be implemented as a program executing on a device, as program instructions stored in a memory medium (e.g., of the device) which are executable by the processor to perform the method, or as a device which is configured to perform the method, as desired.

In alternate embodiments, a management server or management software may assist in managing the device. For example, the email message addressed to the email address of the device may be received by the management server software (e.g., checked for on an email server and then downloaded). In some embodiments, the message may be in the inbox of the device (e.g., the email address of the device) or the message may be forwarded by the mailbox of the device to the mailbox of the management software. As indicated above, a body of the email message may include one or more commands for the device. The management server may then provide commands contained in the email message to a respective device that was addressed by the email message. In one embodiment, the management server determines the sender and/or permission of the sender, and only provides the commands to the addressed device when the permission of the sender matches the required permissions of the one or more commands.

The device may be caused to initiate or join the videoconference based on the one or more commands. The management server may operate for a plurality of different devices including the device. In other words, the management server may receive email messages for a plurality of different devices and may provide commands to various of the devices as these email messages are received.

### BRIEF DESCRIPTION OF THE DRAWINGS

A better understanding of the present invention may be obtained when the following Detailed Description is considered in conjunction with the following drawings, in which:

FIG. 1 illustrates a local area network comprising various network devices, which is coupled to a wide area network, according to one embodiment;

FIG. 2 illustrates a videoconferencing endpoint network, which is coupled to a wide area network, according to an embodiment;

FIG. 3 illustrates a videoconferencing endpoint, according to an embodiment; and

FIGS. 4-8 are flowchart diagrams illustrating various embodiments for managing a device.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Incorporation by Reference

U.S. Patent Application titled “Video Conferencing System Transcoder”, Ser. No. 11/252,238, which was filed Oct. 17, 2005, whose inventors are Michael L. Kenoyer and Michael V. Jenkins, is hereby incorporated by reference in its entirety as though fully and completely set forth herein.

### Terms

The following is a glossary of terms used in the present application:

Memory Medium—Any of various types of memory devices or storage devices. The term “memory medium” is intended to include an installation medium e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, optical storage, flash memory, etc. The memory medium may comprise other types of memory as well, or combinations thereof. In addition, the memory medium may be located in a first device in which the programs are executed, or may be located in a second different device which connects to the first device over a network, such as the Internet. In the latter instance, the second device may provide program instructions or data to the first device for execution or reference. The term “memory medium” may include two or more memory mediums which may reside in different locations, e.g., in different computers that are connected over a network.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

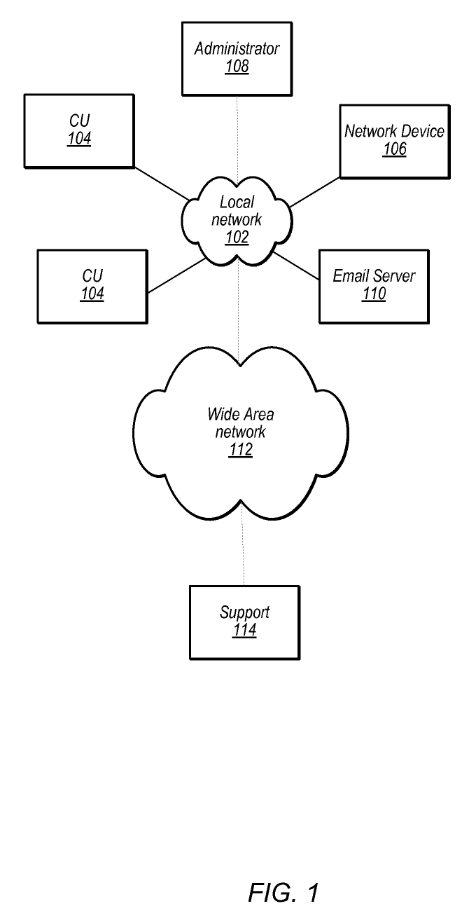

### FIG. 1

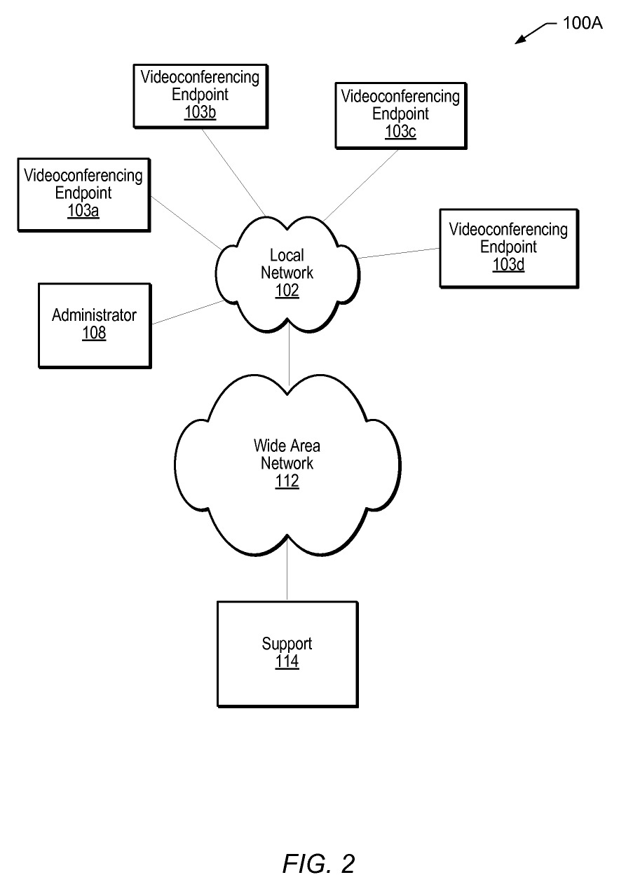

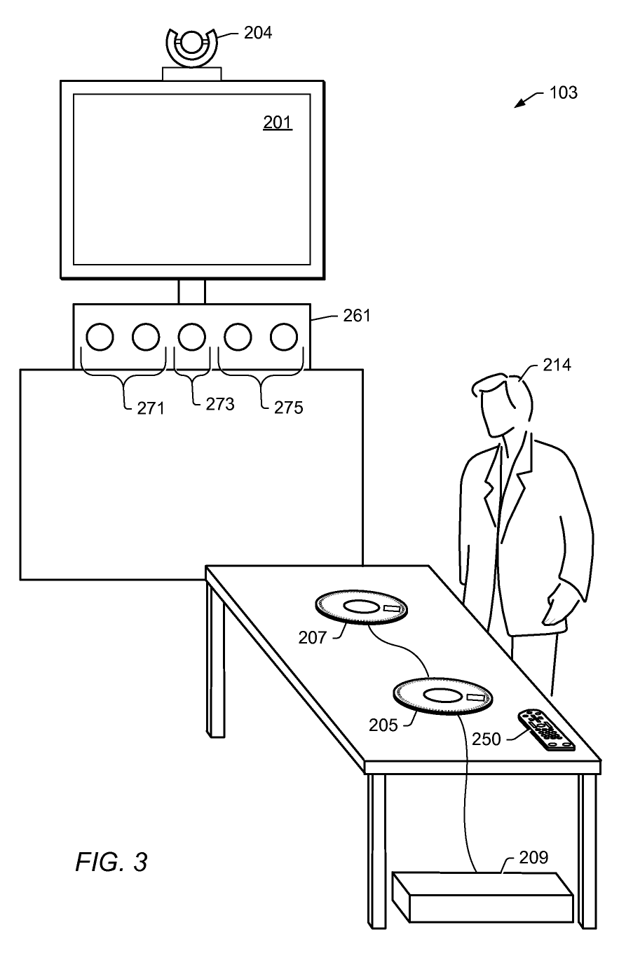

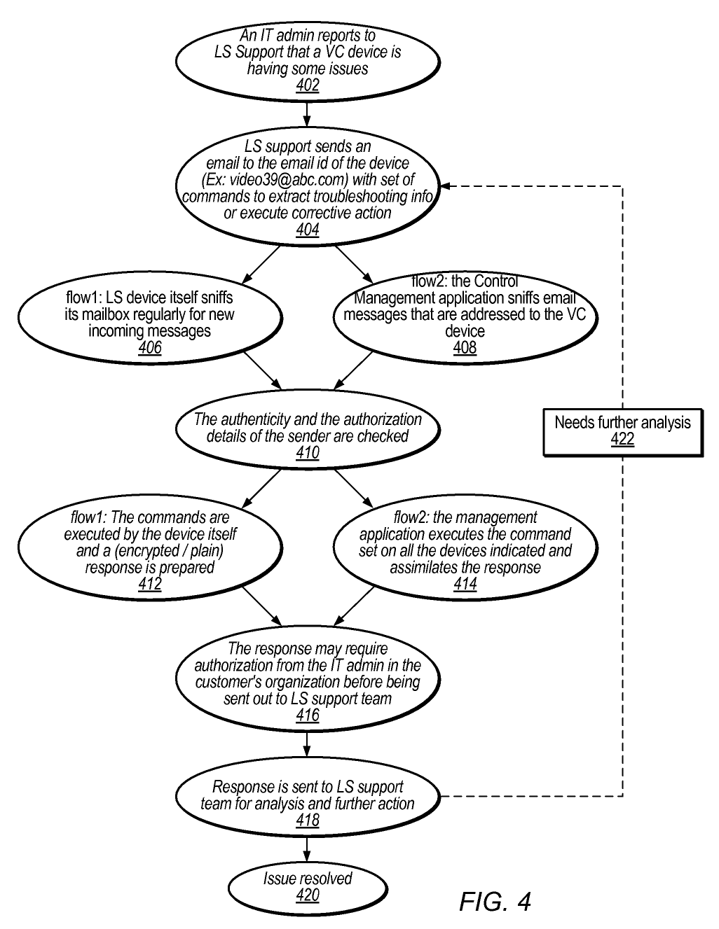

FIG. 1 illustrates an exemplary system comprising a local area network 102 comprising various network devices 104 and 106. The local area network 102 may comprise one or more conferencing units (CUs) 104. The CUs 104 may be speakerphones (audio only) or videoconferencing endpoints (both video and audio. An exemplary videoconferencing endpoint is shown in FIG. 3. The local area network 102 may also comprise one or more network devices 106. The network devices may comprise any of various devices, such as hubs, switches, gateways, servers (e.g., email servers, file servers, etc.), storage devices, etc. In one embodiment the local area network 102 is a videoconferencing network (FIG. 2) comprising various videoconferencing endpoints and optionally one or more audioconferencing endpoints (e.g., speakerphones). In another embodiment, the local area network 102 is a general purpose business LAN that does not comprise any videoconferencing or audioconferencing endpoints, but rather contains various computer systems, servers, network hubs/routers, etc. In still another embodiment, as shown, the local area network 102 may comprise various standard network devices (servers, hubs, routers, switches, gateways, etc.) as well as videoconferencing and/or audioconferencing endpoints.

The local area network 102 is coupled to a wide area network 112, which may be the Internet, according to one embodiment. A Support entity 114 may be coupled to the wide area network 112. For example, a vendor of one or more of the CUs 104 and/or network devices 106 may maintain a computer system 114 for providing support for respective one or more CUs 104 and/or network devices 106 that it sold for use in the local area network 102. The vendor may have support personnel for managing/troubleshooting devices that it has sold for use in the local area network 102. As another alternative, the support entity may be a third party hired by the network device vendor to provide support for the vendor's product, i.e., the vendor's network device being used in the local area network 102.

The LAN 102 may include an email server 110, which may assist in delivering email messages between CUs 104, Administrator 108, support 114, and/or other entities coupled to the LAN 102. In some embodiments, each CU 104 may have a corresponding email address. Each CU 104 may be able to periodically check for email messages addressed to their email address. Alternatively, a support server in the LAN 102 may periodically check for email messages addressed to the CUs 104. As discussed in more detail below, email messages addressed to the CUs 104 may include one or more commands, e.g., for initiating or joining a videoconference, among other possible commands.

### FIG. 2

FIG. 2 illustrates an embodiment of a local area network 100A comprising videoconferencing endpoints. The exemplary embodiment of videoconferencing network 100A may include the local area network 102 and multiple endpoints 103a-103d (e.g., videoconferencing endpoints). While endpoints 103a-d are shown in FIG. 2, videoconferencing endpoint network 100A may include more or fewer endpoints 103. Although not shown in FIG. 2, videoconferencing system network 100 may also include other devices, such as gateways, a service provider, and plain old telephone system (POTS) telephones, among others. Endpoints 103a-103d may be coupled to network 101 via an Ethernet interface or through gateways (not shown). Gateways may each include firewall, network address translation (NAT), packet filter, and/or proxy mechanisms, among others. The videoconferencing network 100A may comprise various other network devices (104 FIG. 1), such as switches, hubs, routers, gateways, etc.

### FIG. 3

FIG. 3 illustrates an exemplary videoconferencing endpoint 103, e.g., an exemplary embodiment of a videoconferencing participant location, also referred to as a videoconferencing system or videoconferencing unit. The videoconferencing system 103 may have a system codec 209 to manage both a speakerphone 205/207 and videoconferencing hardware, e.g., camera 204, speakers 271, 273, 275, etc. The speakerphones 205/207 and other videoconferencing system components may be coupled to the codec 209 and may receive audio and/or video signals from the system codec 209.

In some embodiments, the participant location may include camera 204 (e.g., an HD camera) for acquiring images (e.g., of participant 214) of the participant location. Other cameras are also contemplated. The participant location may also include a display 201 (e.g., an HDTV display). Images acquired by the camera 204 may be displayed locally on the display 201 and may also be encoded and transmitted to other participant locations in the videoconference.

The participant location may also include a sound system 261. The sound system 161 may include multiple speakers including left speakers 271, center speaker 273, and right speakers 275. Other numbers of speakers and other speaker configurations may also be used. The videoconferencing system 103 may also use one or more speakerphones 205/207 which may be daisy chained together.

In some embodiments, the videoconferencing system components (e.g., the camera 204, display 201, sound system 261, and speakerphones 205/207) may be coupled to a system codec 209. The system codec 209 may be placed on a desk or on a floor. Other placements are also contemplated. The system codec 209 may receive audio and/or video data from a network, such as a LAN (local area network) or the Internet. The system codec 209 may send the audio to the speakerphone 205/207 and/or sound system 261 and the video to the display 201. The received video may be HD video that is displayed on the HD display. The system codec 209 may also receive video data from the camera 204 and audio data from the speakerphones 205/207 and transmit the video and/or audio data over the network to another conferencing system. The conferencing system may be controlled by a participant through the user input components (e.g., buttons) on the speakerphones 205/207 and/or remote control 250. Other system interfaces may also be used.

In various embodiments, a codec may implement a real time transmission protocol. In some embodiments, a codec (which may mean short for “compressor/decompressor”) may comprise any system and/or method for encoding and/or decoding (e.g., compressing and decompressing) data (e.g., audio and/or video data). For example, communication applications may use codecs to convert an analog signal to a digital signal for transmitting over various digital networks (e.g., network, PSTN, the Internet, etc.) and to convert a received digital signal to an analog signal. In various embodiments, codecs may be implemented in software, hardware, or a combination of both. Some codecs for computer video and/or audio may include MPEG, Indco™, and Cinepak™, among others.

In some embodiments, the videoconferencing system 103 may be designed to operate with normal display or high definition (HD) display capabilities. The videoconferencing system 103 may operate with a network infrastructures that support T1 capabilities or less, e.g., 1.5 mega-bits per second or less in one embodiment, and 2 mega-bits per second in other embodiments.

Note that the videoconferencing system(s) described herein may be dedicated videoconferencing systems (i.e., whose purpose is to provide videoconferencing) or general purpose computers (e.g., IBM-compatible PC, Mac, etc.) executing videoconferencing software (e.g., a general purpose computer for using user applications, one of which performs videoconferencing). A dedicated videoconferencing system may be designed specifically for videoconferencing, and is not used as a general purpose computing platform; for example, the dedicated videoconferencing system may execute an operating system which may be typically streamlined (or “locked down”) to run one or more applications to provide videoconferencing, e.g., for a conference room of a company. In other embodiments, the videoconferencing system may be a general use computer (e.g., a typical computer system which may be used by the general public or a high end computer system used by corporations) which can execute a plurality of third party applications, one of which provides videoconferencing capabilities. Videoconferencing systems may be complex (such as the videoconferencing system shown in FIG. 3) or simple (e.g., a user computer system with a video camera, microphone and/or speakers). Thus, references to videoconferencing systems, endpoints, etc. herein may refer to general computer systems which execute videoconferencing applications or dedicated videoconferencing systems. Note further that references to the videoconferencing systems performing actions may refer to the videoconferencing application(s) executed by the videoconferencing systems performing the actions (i.e., being executed to perform the actions).

The videoconferencing system 103 may execute various videoconferencing application software that presents a graphical user interface (GUI) on the display 101. The GUI may be used to present an address book, contact list, list of previous callees (call list) and/or other information indicating other videoconferencing systems that the user may desire to call to conduct a videoconference.

One embodiment of the invention relates to a software implemented method for enabling support teams from vendors and IT administrators to debug their network connected devices (or entities) that are deployed inside closed networks using email messages. Besides aiding troubleshooting, embodiments described herein also enable administrators to query for status and other information from network devices (e.g., endpoints) over email. A network management solution engine(s) may be configured to interpret the email messages received in its email inbox and will respond to the received message via email messages with the required information after obtaining authorization. Various environmental parameters, network conditions, hardware states, etc. can be managed using these messages. The disclosure allows administrators and support personnel to use a familiar interface (email) that is available at all times to initiate management operations on the network connected devices.

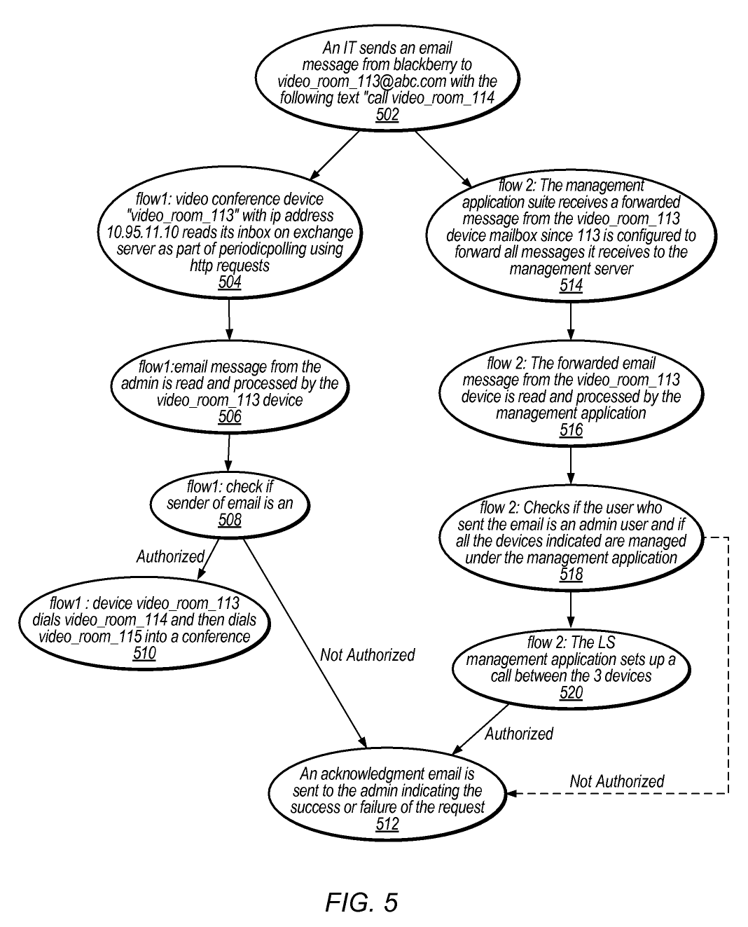

### FIGS. 4 and 5

FIGS. 4 and 5 illustrate specific examples of a method for managing a device, e.g., a videoconferencing device. The method shown in FIGS. 4 and 5 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In 402, an IT administrator may report to support that a videoconferencing device is having issues.

In 404, support may send an email message to the email address of the device with a set of commands to extract troubleshooting information or execute corrective action.

In 406 (flow 1), the videoconferencing device itself may check its mailbox regularly for new incoming message and receive the email message sent in 504. This may be accomplished by a polling procedure performed by software executing on the videoconferencing device.

Alternatively, in 408 (flow 2), a management application may check for email messages addressed to the videoconferencing device. The management application may be configured to automatically forward received email messages to the videoconferencing device. Alternatively, the management application may be configured to generate a message, such as an interrupt, to the device when an email message addressed to the videoconferencing device is received. This may then cause the device to retrieve the email message.

In 410, the authenticity and the authorization details of the sender may be checked (e.g., the sender's address may be compared to a table of authorized email addresses).

In 412 (flow 1), the device may execute the commands and a response may be prepared. The response may be encrypted or provided without encryption, as desired.

Alternatively, in 414 (flow 2), the management application may execute the command set on all the devices indicated in the email message and may assimilate the response(s). In one embodiment, the management application executing the command set may include the management application providing the commands to the device(s) and causing the devices to execute those commands.

In 416, the response may require authorization from the IT administrator before being sent out to external support.

In 418, the response may be sent to the support for analysis and further action.

Based on the response, the issue may be resolved (420) or the process may be repeated (422), e.g., beginning again at 404.

In 502 of FIG. 5, IT may send an email message (e.g., from a BlackBerry™ (provided by RIM) or mobile device) to an email address of a videoconferencing device (e.g., video_room_113). The email message may include one or more commands to initiate or join a videoconference (e.g., “call video_room 114” and/or “call video_room_115” may be included in the body of the email message).

Following flow 1, in 504, the videoconference device (e.g., video room_113 with IP address 10.95.11.10) may check its email address, e.g., on an Microsoft Exchange™ server periodically.

In 506, the email message from the IT admin may be read and processed by the videoconferencing device.

In 508, the videoconferencing device may determine if the sender of the email has proper authorization.

If the sender is authorized, in 510, the videoconferencing device may execute the one or more commands. For example, the videoconferencing device (video_room_113) may initiate a videoconference with one or more other videoconferencing devices (e.g., video_room_114 and/or video_room_115), possibly by dialing those devices, e.g., using an IP address or telephone number. After executing the command, an acknowledgement email may be sent to the IT admin indicating success in 512.

If the sender is not authorized, an acknowledgement email indicating the failure of the request may be sent in 512.

Following flow 2, in 514, the management application may receive a forwarded message from the videoconferencing device or may simply check the inbox of videoconferencing device (e.g., video_room_113). Alternatively, the management application may receive an email to its own inbox, but which indicates that some of the commands are for the videoconferencing device.

In 516, the email message may be read and processed by the management application.

In 518, if the user who sent the email is an admin user (or other authorized user) and if all the devices indicated in the email message (where more than one device is indicated in the email message) are managed by the management application.

In 520, if the user is authorized, the management application may establish a videoconference (based on the email message) between a plurality of devices (e.g., video_room_113, video_room_114, and/or video_room_115). An acknowledgement email indicating success of the request may be transmitted in 512.

If the sender is not authorized, an acknowledgement email indicating the failure of the request may be sent in 512.

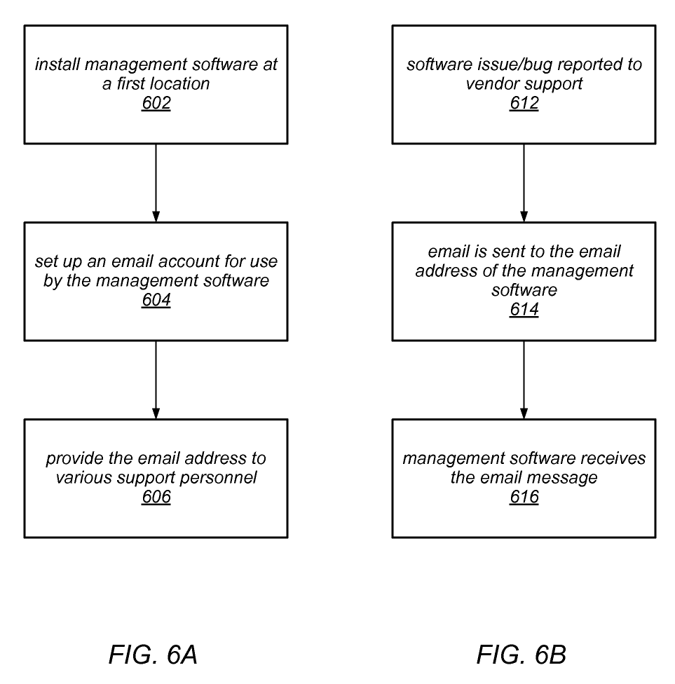

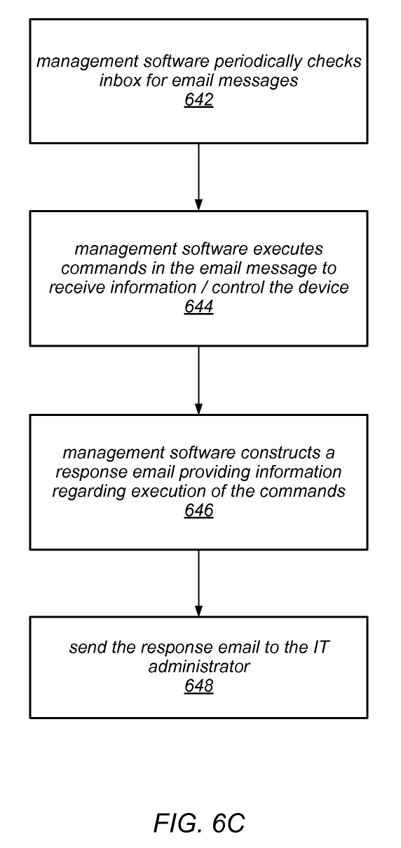

### FIGS. 6A-6C

FIGS. 6A-6C illustrates an exemplary embodiment of a method for managing a device, e.g., a videoconferencing device. More specifically, FIGS. 6A-6C are flowchart diagrams illustrating various embodiments of a method for remote management of network devices using email messages. The method shown in FIGS. 6A-6C may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

At 602 management software is installed at a first location, e.g., on a server at the first location. In various embodiments, the first location (e.g., the server) may be a computer system in a local area network (such as LAN 102) which includes various network devices, e.g., videoconferencing units.

At 604 an email account for use by the management software may be configured or setup at the first location. The email account may be setup in 604 at the time of installation of the management software, prior to the installation in 602, or after the installation in 602, as desired. The management software may be configured to send and receive email messages to/from this email account. For example, account credentials may be configured in the management software to enable the management software to use the email account (e.g., to check for and download messages intended for the device). In one embodiment, an email account may be configured for each device that may be managed. Thus, each managed device may have its own dedicated email account. The device may be a network attached device (e.g., a videoconferencing unit or device) or may be connected to a computer system (e.g., via USB), as desired.

In one embodiment, the administrator creates a mailbox, such as a MICROSOFT EXCHANGE™ mailbox, for this device on the active directory server. The credentials of the mailbox and Exchange server details may be supplied to the device (e.g., endpoint) as part of its setup wizard. Thus the network devices that are deployed in an enterprise can have an inbox of their own on the email server, e.g., the MS Exchange or Lotus Domino server, and can check the emails periodically for commands/actions to be performed.

At 606 the email address may be published, e.g., by the IT administrator, to the support personnel of the vendors who supplied the network connected devices and the management solution. The email address may also be provided to other videoconferencing units or devices coupled to the device.

FIG. 6B illustrates operations that may be performed when an issue is detected in a network device. At 612 when an issue or bug is detected, e.g., by the IT administrator, information regarding this issue may be provided to the vendor support personnel. The information regarding this issue may be provided in any of various ways, such as email, telephone call, etc.

At 614 an email is sent to the email address of the management software and/or the network device. For example, the support person can send the email to the email address of the management software and/or to an email address of the network device (which may be checked by the management software). Alternatively, at 614 the support person can send an email to the IT administrator, who in turn forwards the email to the email address of the management software or device. The email may include a set of instructions or commands for obtaining information (e.g., status information, such as for environmental parameters, network conditions, hardware states, etc.) fetched from the network device in question.

At 616, the management software may receive the email message.

FIG. 6C illustrates operations that may be performed by the management software. At 642 the management software periodically checks its inbox (or an inbox of the device) for email messages. The management software may be configured to check messages for a plurality of devices, e.g., using a single email address (e.g., its own) for a plurality of devices. In one embodiment, the single email message may be usable to manage a plurality of devices. For example, the email message may include a plurality of commands, subsets of which may be directed for controlling respective devices. Thus a first one or more commands in an email message could be for managing a first device while a second one or more commands in the email message could be for managing a second device. Thus, the single email message may provide an ability for managing a plurality of devices. Alternatively, the management software may check a plurality of email addresses for each of the plurality of devices (where each email address corresponds to a respective device) and email messages may be for managing a single device (i.e., for managing the device to which the email message is sent, as indicated by the email address of the device).

At 644 the management software may execute commands or instructions in the email message in the managed network. Execution of the commands may cause the management software to request and/or modify a configuration/settings of the network device to identify and/or correct the issue. Alternatively, or additionally, execution of the commands may cause the device (e.g., where the device is a videoconferencing device such as a videoconferencing unit) to initiate or join a videoconference with a plurality of other videoconferencing devices. Execution of the commands may also cause a device that is currently in a videoconference to perform some functionality, such as changing its display, providing additional or alternate video outputs to the videoconference, increasing volume, etc.

Thus, the management application may routinely check its inbox and receives the email messages, interprets the commands in them, and executes the commands on the network connected devices (entities) which it manages within the secure network.

In some embodiments, the management software may construct a response email to the support server providing information regarding execution of the commands (646). The response email may indicate what steps were performed as well as any information received from the network device responsive to the executed commands.

In 648, the management software may send the response email to the IT administrator for approval. The administrator may review the information in the response email and determine if the information can be sent across to the support person. The response email may then be forwarded to the vendor's support group. With this, the support person has access to the current state of the network connected device. The support person can thus debug the device and/or suggest/implement a solution.

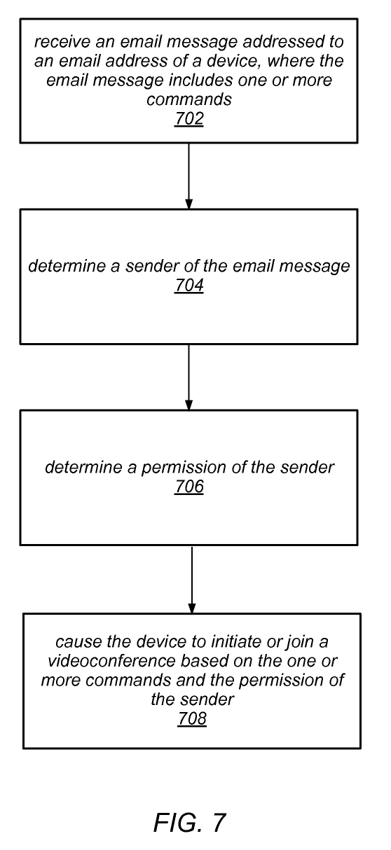

### FIG. 7

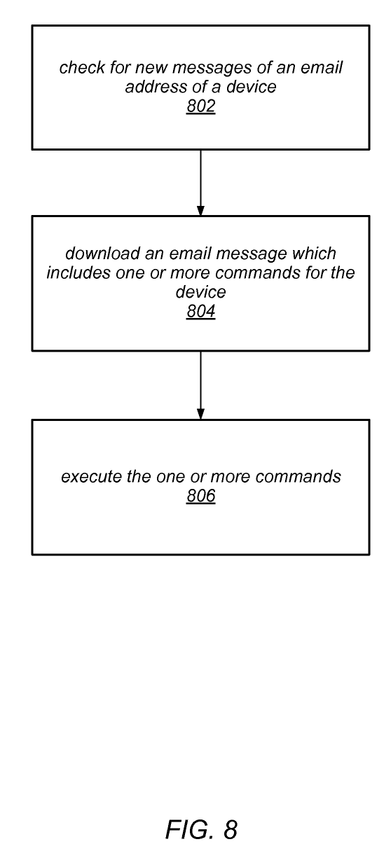

FIG. 7 is a flowchart diagram illustrating an exemplary embodiment of a method for managing a device, e.g., a videoconferencing device based on an email message. The method shown in FIG. 8 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In 702, an email message addressed to an email address of a device may be received. The email message may be received and downloaded by a management server (or management software executing on a computer system) that is coupled to the device. In one embodiment, the management server may periodically check the email address of the device, and when a new message is available, may download the message. As indicated above, the management server may be able to perform this functionality for a plurality of devices each having its own email address. Alternatively, messages may be delivered to the management server's email address and include commands which are indicated for various ones (or a plurality) of the devices.

As described above, the email message may include one or more commands (e.g., in the body of the email message) for managing the device. For example, the one or more commands may be for causing a device to initiate or join a videoconference, retrieving troubleshooting information, upgrading software or firmware, etc.

Similar to descriptions provided herein (e.g., in FIG. 8 below), in 704, a sender of the email message may be determined, and in 706, a permission of the sender may be determined. Checking the permission of the sender may be performed locally, e.g., by the server, or remotely, as desired.

In 708, the device may be caused to initiate or join a videoconference based on the one or more commands and the permission of the sender. Causing the device to initiate or join the videoconference may include providing the commands to the device and the device executing those commands. Alternatively, the commands may be executable by the management server to cause the device to initiate or join the videoconference, e.g., by providing one or more messages or different commands to the device.

### FIG. 8

FIG. 8 is a flowchart diagram illustrating an exemplary embodiment of a method for a device, e.g., a videoconferencing device, executing one or more commands based on an email message. The method shown in FIG. 7 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In 802, the device may check for new messages of an email address of the device. For example, the device may check for new messages on a server (e.g., located in the LAN 102 described above or elsewhere).

In 804, an email message sent to the email address may be downloaded and stored to a memory medium of the device. The email message may include one or more commands for execution by the device. For example, the one or more commands may be included in the body of the email message and/or a subject of the email message. For example, the body of the email message may include commands for executing various procedures or applications on the device (e.g., to initiate or join a videoconference, to perform a videoconferencing operation, update software or firmware of the device, report debugging information, report status information, fetch a snapshot for a near camera, etc.). As one example, shown above, the message may include a command “call device_x” or “call contact” (where device_x and contact are replaced with device names or contact names, possibly stored in an address book of the device). In various embodiments, the email message and/or the commands may be encrypted or provided as clear text, as desired.

As another example, the one or more commands may include command(s) for upgrading or downgrading firmware or software of the device. For example, the email message may include a command to upgrade the device and may attach a file for performing the upgrade. Alternatively, the email message could include a URL for downloading an upgrade file. Similarly, the email message may include a command to downgrade the device and may include a file or URL for downgrading the device.

In some embodiments, the email message and/or commands may include scheduling information which may indicate when the commands should be executed. For example, the one or more commands may schedule a future videoconference at a later date or time. Correspondingly, a calendar may be updated for executing the commands (in 806 below) at the scheduled time. Thus, the one or more commands may include at least one command for initiating or joining a videoconference.

In 806, the one or more commands may be executed. In embodiments where the commands include at least one for initiating or joining the videoconference, the device may correspondingly initiate or join the videoconference and perform videoconferencing with at least one other videoconferencing device.

The one or more commands may be executed automatically without manual input required to specify execution of the commands. For example, the email may be sent to the device, the device may check and download the message, and the one or more commands may be executed all without any input from a user at the device.

Execution of the one or more commands may be dependent on privileges of the sender of the email message. For example, the method may include determining a sender of the email message. In some embodiments, this may be simply determining the sender email address. Alternatively, or additionally, the email message may include an identification string (e.g., in the body of the email message) which may indicate the sender or indicate an authorization of the sender.

Correspondingly, the device may determine whether the sender has proper permissions for managing the device. For example, the device may include a table which indicates which users are able to manage the device. Alternatively, the device may be able to access a table or provide the sender address to a server which can determine permissions of the sender. In one embodiment, this may involve checking the email address of the sender against a list of known email addresses who have proper privileges. Alternatively, or additionally, an authorization code may be required (e.g., which may be unique to the videoconferencing device) from the sender (e.g., in the email message or in a subsequent communication).

In some embodiments, privileges may be tiered or multi-layer. For example, administrative users (having full privileges) may be able to execute all of the available commands of the device (e.g., upgrading firmware, performing diagnostics, changing settings, etc.) while normal users (e.g., end users) may only be able to execute some of the available commands (e.g., initiating or joining a videoconference, etc.). Thus, the device may be able to determine which level of access the sender has and then determine if the commands in the email message correspond to that level. Where these do not match, the device may execute only the commands that match the level of access of the sender. Alternatively, or additionally (e.g., depending on a setting of the device), the device may simply ignore the request if the access level does not match the required level of access of any of the commands.

Prior to execution, the device may be further configured to determine authenticity of a sender of the email message. For example, the device may be configured to send a response message to the user (e.g., including a verification code) and have the user provide a response (e.g., with a response code that is unique to that user, such as a predetermined password). This may avoid situations where the user's sender address has been “spoofed” or the message has been otherwise sent without the knowledge of the sender. Alternatively, the email message may be digitally signed by the sender, and the device (and/or an external device) may be able to authenticate the digital signature. Other methods for authenticating the sender are envisioned.

### Advantages and Alternatives

Embodiments of the invention may have applications and provide various advantages, such as:

Email based Remote management of a network device deployed in a secure environment.

A multi hop seamless debug procedure which provides information protection

Can avoid the need to place the network devices on public IP addresses for debugging by the vendor's support personnel.

Easy “one to many” management possible wherein multiple devices can be managed using a single email message.

The method may operate across enterprises as embodiments may not be tied to any specific email solution like Microsoft Exchange, IBM Lotus notes, etc.

Provides management access through email which is a ubiquitous tool that is even available even when the administrator/support personnel are not at their desk or in front of their computer.

Devices may be able to poll or check their own email addresses without the need of a management server.

Scheduling conferences between video conferencing devices may be much easier than prior art methods.

Remote management of network devices may be easier than prior art methods.

Free/Busy schedules of the devices may be easily checked by looking at the device's calendar.

Note that while the above descriptions relate to an email message, similar techniques may be applied to SMS messages, online chat messages, and/or other types of electronic messages (e.g., where each device is able to receive such messages).

Although the embodiments above have been described in considerable detail, numerous variations and modifications will become apparent to those skilled in the art once the above disclosure is fully appreciated. It is intended that the following claims be interpreted to embrace all such variations and modifications.

1. A computer readable memory medium comprising program instructions, wherein the memory medium is comprised in a device, and wherein the program instructions are executable to:
check for new messages of an email address of the device on a server;
download an email message from the server based on said checking, wherein the email message is addressed to the email address of the device, wherein a body of the email message comprises one or more commands for the device; and
execute the one or more commands comprised in the email message.

2. The memory medium of claim 1,
wherein the device is a videoconferencing device;
wherein the one or more commands comprise a first command for initiating or joining a videoconference, and wherein the program instructions are further executable to:
cause the device to join the videoconference based on execution of the first command.

3. The memory medium of claim 1, wherein the program instructions are executable to automatically execute the one or more commands without manual user input required to specify execution of the commands.

4. The memory medium of claim 1, wherein the program instructions are further executable to:
determine a sender of the email message;
determine a permission of the sender;
wherein execution of the one or more commands is performed based on the permission of the sender.

5. The memory medium of claim 1, wherein the program instructions are further executable to:
determine authenticity of a sender of the email message prior to execution of the one or more commands.

6. The memory medium of claim 1, wherein the one or more commands comprise a first command for upgrading or downgrading the device, and wherein the program instructions are further executable to:
cause the device to upgrade or downgrade based on the first command.

7. The memory medium of claim 1, wherein the one or more commands comprise a first command for providing diagnostic data, and wherein the program instructions are further executable to:
cause the device to provide diagnostic data based on the first command.

8. A method, comprising:
a device checking for new messages of an email address of the device on a server;
the device downloading an email message from the server based on said checking, wherein the email message is addressed to the email address of the device, wherein the email message comprises one or more commands for the device; and
the device executing the one or more commands comprised in the email message.

9. The method of claim 8,
wherein the device is a videoconferencing device;
wherein the one or more commands comprise a first command for initiating or joining a videoconference, and wherein the method further comprises:
causing the device to join the videoconference based on execution of the first command.

10. The method of claim 8, said executing is performed automatically without manual user input required to specify execution of the commands.

11. The method of claim 8, further comprising:
determining a sender of the email message;
determining a permission of the sender;
wherein said executing of the one or more commands is performed based on the permission of the sender.

12. The method of claim 8, further comprising:
determining authenticity of a sender of the email message prior to execution of the one or more commands.

13. The method of claim 8, wherein the one or more commands comprise a first command for upgrading or downgrading the device, and wherein the method further comprises:
causing the device to upgrade or downgrade based on the first command.

14. The method of claim 8, wherein the one or more commands comprise a first command for providing diagnostic data, and wherein the method further comprises:
causing the device to provide diagnostic data based on the first command.

15. A videoconferencing device, wherein the videoconferencing device comprises:
a processor;
a network port coupled to the processor, wherein the network port is configured to couple to a network;
a memory medium coupled to the processor, wherein the memory medium stores program instructions, and wherein the program instructions are executable by the processor to:
check for new messages of an email address of the device on a server using the network;
download an email message from the server over the network based on said checking, wherein the email message is addressed to the email address of the device, wherein a body of the email message comprises one or more commands for the device; and
execute the one or more commands comprised in the email message.

16. The videoconferencing device of claim 15,
wherein the one or more commands comprise a first command for initiating or joining a videoconference, and wherein the program instructions are further executable to:
cause the device to join the videoconference based on execution of the first command.

17. The videoconferencing device of claim 15, wherein the program instructions are executable to automatically execute the one or more commands without manual user input required to specify execution of the commands.

18. The videoconferencing device of claim 15, wherein the program instructions are further executable to:
determine a sender of the email message;
determine a permission of the sender;
wherein execution of the one or more commands is performed based on the permission of the sender.

19. The videoconferencing device of claim 15, further comprising:
a display coupled to the processor for displaying videoconferencing signals of a videoconference; and
an audio input for receiving audio signals for the videoconference.

20. A computer readable memory medium comprising program instructions for causing a device to initiate or join a videoconference, wherein the program instructions are executable to:
receive an email message addressed to an email address of the device, wherein a body of the email message comprises one or more commands for the device, wherein at least one of the one or more commands is for causing the device to initiate or join the videoconference;
cause the device to initiate or join the videoconference based on the one or more commands.

21. The memory medium of claim 20, wherein the memory medium is comprised in the device, wherein said causing the device to initiate or join the videoconference comprises executing the one or more commands to initiate or join the videoconference.

22. The memory medium of claim 20, wherein the program instructions are further executable to:
determine a sender of the email message;
determine a permission of the sender;
wherein said causing is performed based on the permission of the sender.

23. The memory medium of claim 20, wherein the memory medium is comprised in a computer system coupled to the device, wherein said causing the device to initiate or join the videoconference comprises:
providing the one or more commands to the device to cause the device to initiate or join the videoconference.

24. The memory medium of claim 20, wherein the program instructions are executable to perform said receiving and said causing for a plurality of devices including the device, and wherein said receiving the email message is performed for each email address of a respective device.

25. A computer readable memory medium comprising program instructions for initiating or joining a videoconference, wherein the memory medium is comprised in a device, and wherein the program instructions are executable to:
receive an email message addressed to an email address of the device, wherein the email message comprises one or more commands for the device, wherein at least one of the one or more commands is for initiating or joining the videoconference;
executing the one or more commands comprised in the email message, wherein said executing the one or more commands comprises executing the at least one of the commands to initiate or join the videoconference;
performing videoconferencing with one or more other devices based on said initiating or joining the videoconference.

26. A computer readable memory medium comprising program instructions for causing a device to perform a videoconferencing operation, wherein the program instructions are executable to:
receive an email message addressed to an email address of the device, wherein a body of the email message comprises one or more commands for the device, wherein at least one of the one or more commands is for causing the device to perform a videoconferencing operation;
wherein the device is currently in a videoconference;
the device performing a videoconferencing operation in the videoconference based on the one or more commands.
